(19) United States
(12) Patent Application Publication
(10) Pub. No.: US 2018/0136125 A1
(43) Pub. Date: May 17, 2018

(54) METHOD FOR DETECTING CLARITY OF TRANSPARENT DISPLAY PANEL AND DETECTING APPARATUS THEREOF

(71) Applicant: BOE TECHNOLOGY GROUP CO., LTD., Beijing (CN)

(72) Inventors: Hangman LAI, Beijing (CN); Zhigang ZHANG, Beijing (CN)

(73) Assignee: BOE TECHNOLOGY GROUP CO., LTD., Beijing (CN)

(21) Appl. No.: 15/539,801

(22) PCT Filed: Oct. 24, 2016
(86) PCT No.: PCT/CN2016/103003

§ 371 Date: Jun. 26, 2017

(30) Foreign Application Priority Data
Mar. 28, 2016 (CN) 201610181493.2

(51) Int. Cl. G01N 21/59

(52) U.S. Cl. CPC G01N 21/59; G01N 2201/063

(57) ABSTRACT

A method for detecting a clarity of a transparent display panel and a detecting apparatus thereof are provided. The detecting method includes: detecting directly a reference pattern sheet by a measuring device to obtain a without-panel measurement value of the reference pattern sheet; placing the transparent display panel between the measuring device and the reference pattern sheet; detecting the reference pattern sheet through the transparent display panel to obtain a with-panel measurement value of the reference pattern sheet; acquiring clarity of the transparent display panel according to the without-panel and with-panel measurement value; wherein, the reference pattern sheet includes a plurality of pattern groups sequentially arranged in a first direction, each of which includes a first region and a second region, and widths of the plurality of pattern groups in the first direction are different. The detecting method can better evaluate a transparent effect of the transparent display panel.

### TECHNICAL FIELD

At least one embodiment of the present disclosure relates to a method for detecting a clarity of a transparent display panel and a detecting apparatus thereof.

### BACKGROUND

Along with development of information technology, a transparent display technology arouses people's attraction increasingly. In order to evaluate a transparent effect of a transparent display, it is needed to measure a clarity of an object at the back of a transparent display panel. The transparent display panel has certain transparency, that is to say, information can be displayed on the transparent display panel, and a background behind can also be seen through the transparent display panel when the information is displayed on the transparent display panel or not displayed on the transparent display panel. The transparent display panel can be applicable to building external walls, display windows, exhibition panels, vending machines, closets, transparent refrigerators or car windows and provides advertisements, image interfaces and other contents.

### SUMMARY

At least one embodiment of the present disclosure provides a method for detecting a clarity of a transparent display panel and a detecting apparatus thereof, which can better evaluate a transparent effect of the transparent display panel.

Embodiments of the present disclosure provide a method for detecting a clarity of a transparent display panel, including: detecting directly a reference pattern sheet by a measuring device separated from the reference pattern sheet by a certain distance to obtain a without-panel measurement value of the reference pattern sheet; placing the transparent display panel between the measuring device and the reference pattern sheet; detecting the reference pattern sheet by the measuring device through the transparent display panel to obtain a with-panel measurement value of the reference pattern sheet; acquiring clarity of the transparent display panel according to the without-panel measurement value and the with-panel measurement value; wherein, the reference pattern sheet includes a plurality of pattern groups sequentially arranged in a first direction, each of the plurality of pattern groups includes a first region and a second region, the first region has a first color, the second region has a second color different from the first color, and widths of the plurality of pattern groups in the first direction are different.

Embodiments of the present disclosure further provide an apparatus for detecting a clarity of a transparent display panel, including: a reference pattern sheet and a measuring device, wherein, the reference pattern sheet includes a plurality of pattern groups sequentially arranged in a first direction, each of the plurality of pattern groups includes a first region and a second region, the first region has a first color, the second region has a second color different from the first color, and widths of the plurality of pattern groups in the first direction are different; the measuring device is arranged to be separated from the reference pattern sheet by a predetermined distance, and is configured to perform measurement in cases that the transparent display panel is not placed between the measuring device and the reference pattern sheet and the transparent display panel is placed between the measuring device and the reference pattern sheet so as to acquire a without-panel measurement value and a with-panel measurement value of the reference pattern sheet.

### BRIEF DESCRIPTION OF THE DRAWINGS

In order to clearly illustrate the technical solution of the embodiments of the disclosure, the drawings of the embodiments will be briefly described in the following; it is obvious that the described drawings are only related to some embodiments of the disclosure and thus are not limitative of the invention.

FIG. 1 is a schematic diagram of a method for detecting a clarity of a transparent display panel provided by an embodiment of the present disclosure;

FIG. 2a is a schematic diagram of a reference pattern sheet provided by one example of the embodiment of the present disclosure;

FIG. 2b is a schematic diagram of a reference pattern sheet provided by another example of the embodiment of the present disclosure;

FIG. 2c is a schematic diagram of a reference pattern sheet provided by another example of the embodiment of the present disclosure;

FIGS. 3a to 3c are schematic diagrams of a reference pattern sheet provided by another example of the embodiment of the present disclosure;

FIG. 4 is a curve in which clarities of a transparent display panel provided by one example of the embodiment of the present disclosure change along with a line pair frequency;

FIG. 5 is a schematic diagram of a brightness curve measured by one example of the embodiment of the present disclosure; and

FIG. 6 is a schematic diagram of an apparatus for detecting a clarity of a transparent display panel according to an embodiment of the present disclosure.

### REFERENCE NUMERALS

1—reference pattern sheet; 2—measuring device; 3—transparent display panel; 10—pattern group; 101—first pattern group; 102—second pattern group; 103—third pattern group; 1001—first region; 1002—second region; 4—transparent display panel support device; 5—evaluating device.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any inventive work, which should be within the scope of the invention.

Unless otherwise defined, all the technical and scientific terms used herein have the same meanings as commonly understood by one of ordinary skill in the art to which the present disclosure belongs. The terms “first,” “second,” etc., which are used in the description and the claims of the present disclosure, are not intended to indicate any sequence, amount or importance, but distinguish various components. Also, the terms such as “a,” “an,” etc., are not intended to limit the amount, but indicate the existence of at least one. The terms “comprise,” “comprising,” “include,” “including,” etc., are intended to specify that the elements or the objects stated before these terms encompass the elements or the objects and equivalents thereof listed after these terms, but do not preclude the other elements or objects. The phrases “connect”, “connected”, etc., are not intended to define a physical connection or mechanical connection, but can include an electrical connection, directly or indirectly. “On,” “under,” “right,” “left” and the like are only used to indicate relative position relationship, and when the position of the object which is described is changed, the relative position relationship can be changed accordingly.

A transparent effect of a transparent display panel refers to a degree of a clarity of an object observed by human eyes through the transparent display panel.

The transparency of a transparent material is generally characterized by haze. By measuring the haze, the transparent effect of the transparent display panel can be evaluated.

A reference object with black and white fringes can be used, brightness of a black portion and a white portion of the reference object is measured respectively by using a brightness measuring device through the transparent display panel, a ratio of the brightness of the two portions is calculated, and the transparent effect of the transparent display panel is measured by using the ratio. However, the method only takes a contrast of an object behind the transparent display panel into consideration.

As illustrated in FIG. 1, an embodiment of the present disclosure provides a method for detecting a clarity of a transparent display panel. In the method, a measuring device 2 separated from a reference pattern sheet 1 by a certain distance is used for directly detecting the reference pattern sheet 1, and acquires a without-panel measurement value of the reference pattern sheet 1; the transparent display panel 3 is placed between the measuring device 2 and the reference pattern sheet 1; the reference pattern sheet 1 is detected by the measuring device 1 through the transparent display panel 3, and a with-panel measurement value of the reference pattern sheet 1 is acquired; and the clarity of the transparent display panel 3 is acquired according to the without-panel measurement value and the with-panel measurement value.

The reference pattern sheet 1 includes a plurality of pattern groups 10 sequentially arranged (distributed) in a first direction, each of the plurality of pattern groups 10 includes a first region 1001 and a second region 1002, the first region 1001 has a first color, the second region 1002 has a second color different from the first color, and widths of the plurality of pattern groups 10 in the first direction are different.

For example, the first direction refers to a certain direction, and as illustrated in FIG. 1, the first direction refers to an X direction. For example, a plurality of refers to a number greater than one. What needs to be noted is that, in the embodiment of the present disclose, a number of the pattern groups is not limited as illustrated in the drawings.

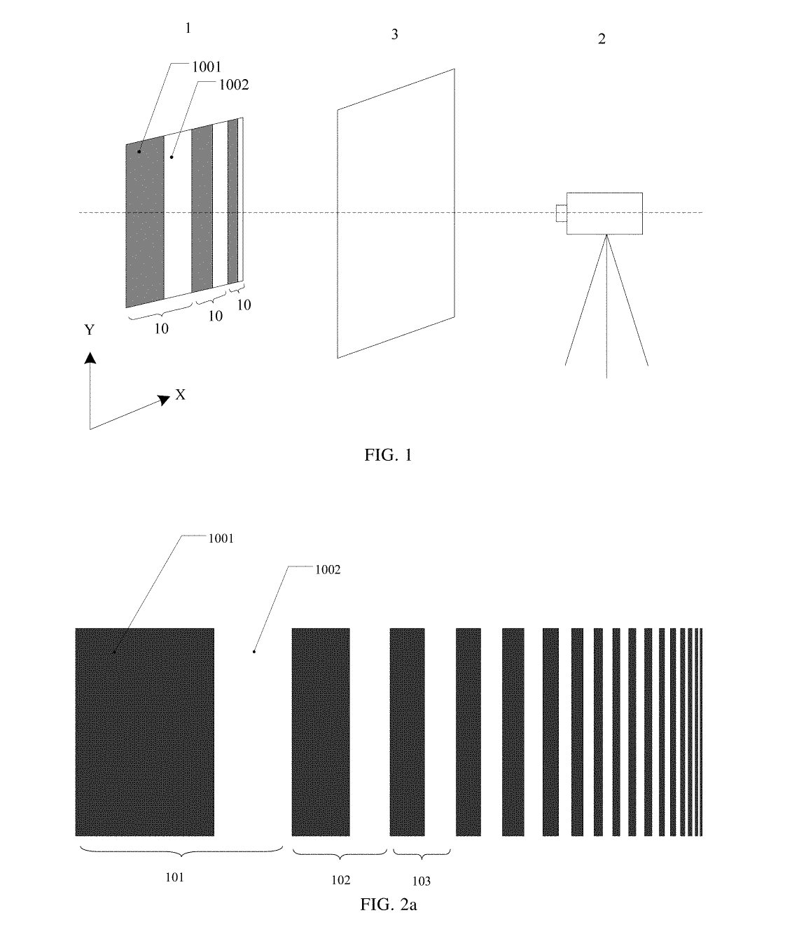

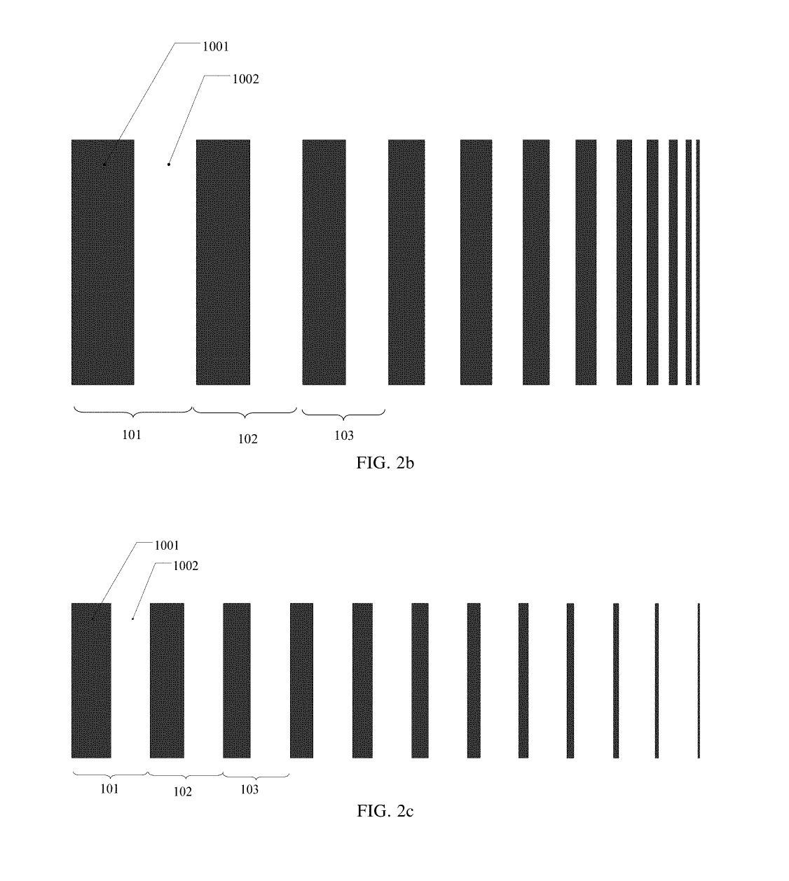

In some examples, as illustrated in FIGS. 2a to 2c, the first region 1002 and the second region 1002 in the reference pattern sheet 1 are strip-shaped patterns extending in a second direction, the second direction is perpendicular to the first direction, and for example, the second direction refers to a Y direction.

In some examples, as illustrated in FIGS. 2a to 2c, the widths of the plurality of pattern groups 10 gradually change in the first direction. For example, a gradual change includes gradual increase and gradual decrease, and FIGS. 2a to 2c are noted with gradual decrease of the widths as an example. Further, in some examples, the widths of the plurality of pattern groups 10 in the first direction gradually change in an arithmetic progression manner. Due to arrangement of the plurality of pattern groups 10 with the widths gradually changing, a gradually changed clarity of the transparent display panel can be acquired.

In some examples, as illustrated in FIG. 2a, the first region 1001 and the second region 1002 in each of the plurality of pattern groups 10 have different widths in the first direction. For example, a width changing tendency of a plurality of first regions 1001 in the first direction and a width changing tendency of a plurality of second regions 1002 in the first direction are the same. For example, the changing tendency includes increase or decrease. In FIG. 2a, widths of the plurality of first regions 1001 in the first direction are gradually decreased, and widths of the plurality of second regions 1002 in the first direction are also gradually decreased. It is noted with a first pattern group 101, a second pattern group 102 and a third pattern group 103 as an example, in the first pattern group 101, the second pattern group 102 and the third pattern group 103, the first region and the second region in each of the plurality of pattern groups have different widths in the first direction, and from left to right, widths of the first pattern group 101, the second pattern group 102 and the third pattern group 103 are gradually decreased. Thus, in the first direction, widths of the plurality of first regions 1001 and the plurality of second regions 1002 which are alternately arranged are sequentially decreased from left to right, which is not limited herein. In some other examples, as illustrated in FIG. 2b, the first region 1001 and the second region 1002 in each of the plurality of pattern groups 10 can also have a same width in the first direction. In FIG. 2b, widths of the plurality of pattern groups 10 are gradually decreased from left to right in the first direction. In another example, as illustrated in FIG. 2c, in the plurality of pattern groups 10, widths of the plurality of first regions 1001 gradually change in the first direction, and widths of the plurality of second regions 1002 do not change. Of course, it can also be that the widths of the plurality of second regions 1002 gradually change in the first direction, and the widths of the plurality of first regions 1001 do not change, which is not limited by the embodiment of the present disclosure.

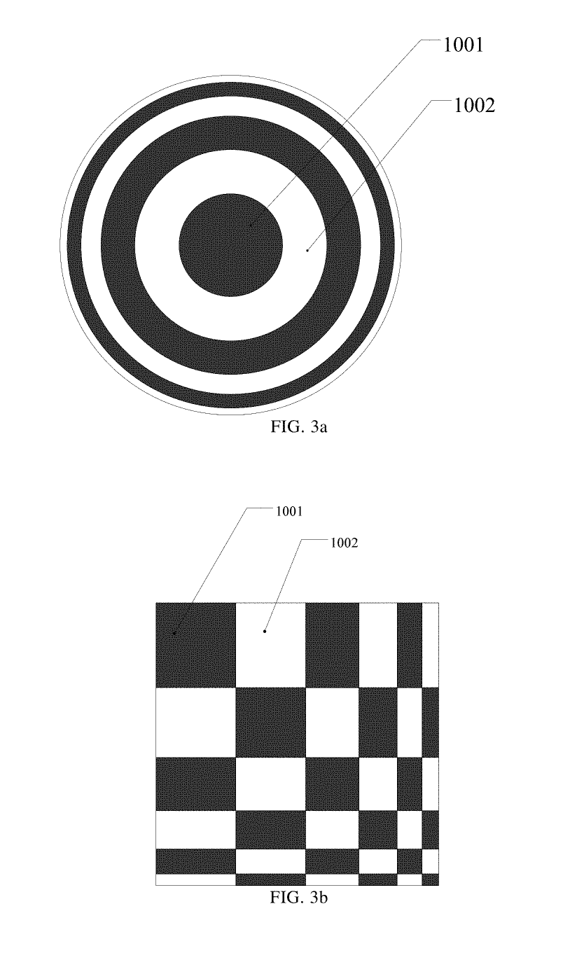

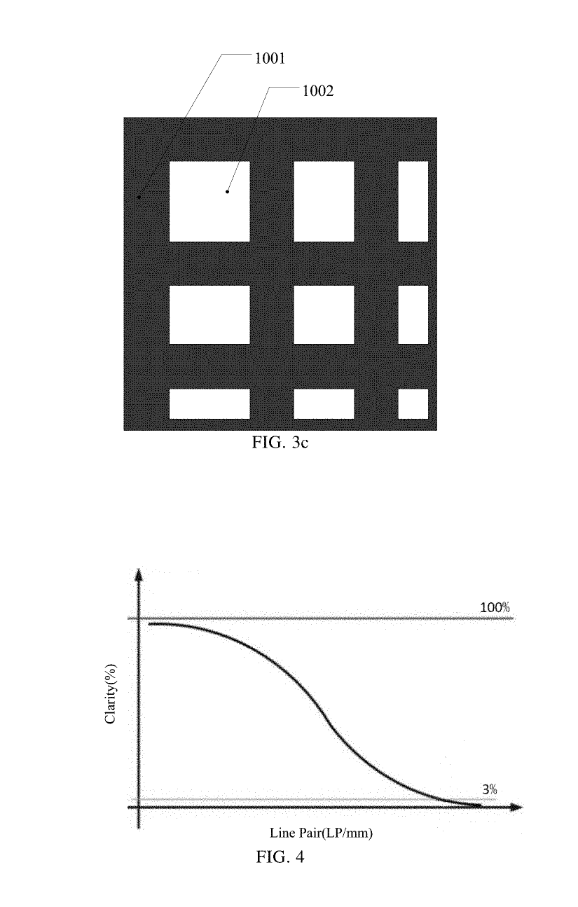

What needs to be noted is that, a pattern of the reference pattern sheet 1 in the embodiment of the present disclosure is not limited as illustrated in FIGS. 2a to 2c, in some examples, for example, as illustrated in FIG. 3a, the reference pattern sheet 1 has an annular target-shaped pattern with the first region 1001 and the second region 1002 nested, and for example, the first direction refers to a radius direction from a circle center to an exterior of a circle; the reference pattern sheet 1 can also has an annular pattern in a shape of a hexagon or an octagon or the like with the first region 1001 and the second region 1002 nested, which is not limited herein. The pattern of the reference pattern sheet 1 can also be as illustrated in FIG. 3b, the reference pattern sheet 1 has a chessboard pattern with the first regions 1001 and the second regions 1002 both alternately arranged in the first direction and the second direction, the second direction is perpendicular to the first direction, and the first region 1001 and the second region 1002 of the reference pattern sheet 1 are rectangles alternately arranged in two directions perpendicular to each other. The pattern of the reference pattern sheet 1 can also be as illustrated in FIG. 3c, the reference pattern sheet 1 has a grid pattern with the first regions 1001 and the second regions 1002 both alternately arranged in the first direction and the second direction, and the second direction is perpendicular to the first direction. The first region 1001 in the reference pattern sheet 1 is of an orthogonal grid structure, and the second region 1002 is a blank region in the grid structure.

What needs to be noted is that, in each of the plurality of pattern groups, except the first region and the second region, other regions can also be included, which is not limited by the embodiment of the present disclosure.

In some examples of the embodiment of the present disclosure, in a process of acquiring the clarity of the transparent display panel according to the without-panel measurement value and the with-panel measurement value, firstly, a without-panel modulation contrast of each of the plurality of pattern groups 10 of the reference pattern sheet 1 is acquired according to the without-panel measurement value; secondly, a with-panel modulation contrast of each of the plurality of pattern groups 10 of the reference pattern sheet 1 is acquired according to the with-panel measurement value; after that, a clarity Cn of the transparent display panel 3 corresponding to an n^{th} pattern group 10 is determined according to a ratio of a with-panel modulation contrast of the n^{th} pattern group 10 to a without-panel modulation contrast of the n^{th} pattern group 10, and the clarity Cn is linearly proportional to the ratio:

Cn=k C′(n)/C(n),

where, C(n) is the without-panel modulation contrast of the n^{th} pattern group 10, C′(n) is the with-panel modulation contrast of the n^{th} pattern group 10, and n is an integer greater than 0, and k is a positive number. For example, in order to make calculation simple and convenient, it can be made that k=1, which is not limited herein, and k can be any positive number. For example, in a case that k is greater than 0 and less than or equal to 1, the clarity of the transparent display panel can range from 0 to 100%, and the greater a numerical value of the clarity is, the better a transparent degree of a corresponding transparent display panel is. In order to facilitate comparison, in different pattern groups in the reference pattern sheet corresponding to a same transparent display panel, values of k can be same. When different transparent display panels are compared, values of k can be the same, which is facilitated comparison.

In these examples, the modulation contrast is used, but not a contrast of the first region 1001 and the second region 1002 is directly used, and a degree of the clarity of the reference pattern sheet 1 can be characterized more objectively and accurately.

In some examples, after the clarity Cn of the transparent display panel 3 corresponding to the n^{th} pattern group 10 is acquired, further including: acquiring a curve in which clarities of the transparent display panel 3 change along with a line pair frequency (fringe frequency) according to a line pair frequency of each of the plurality of pattern groups and the clarity of each of the plurality of pattern groups, so as to acquire the clarities of the transparent display panel 3 under different line pair frequencies, and a line pair frequency (LP/mm) of the n^{th} pattern group is a number of line pairs (LP) of the first region 1001 and the second region 1002 of the n^{th} pattern group in a unit length. For example, supposing that widths of the first region 1001 and the second region 1002 in the n^{th} pattern group 10 are respectively dn1 and dn2 in the first direction, the line pair frequency of the n^{th} pattern group can be 1/(dn1+dn2), that is to say, the line pair frequency of the n^{th} pattern group can be a reciprocal of a sum of the widths of the first region 1001 and the second region 1002 in the n^{th} pattern group 10 in the first direction. The curve in which clarities of the transparent display panel change along with the line pair frequency can be as illustrated in FIG. 4. When different transparent display panels are compared or the same transparent display panel is compared, under a same line pair frequency, the higher the clarity is, the better a transparent effect of the transparent display panel is. However, because a light diffraction phenomenon exists, along with increase of the line pair frequency, the clarity of the transparent display panel is lowered. Thus, it can be acquired that the clarity of the detected transparent display panel is good under which line pair frequency, and for example, under a low line pair frequency or a high line pair frequency, the clarity of the transparent display panel is good.

In some examples, brightness values of the first region 1001 and the second region 1002 in each of the plurality of pattern groups 10 are acquired by measuring a brightness curve of the reference pattern sheet 1. What needs to be noted is that, the embodiment of the present disclosure is not limited herein, and the clarity of the transparent display panel can also be acquired through other measurement values.

In some examples, the without-panel modulation contrast is:

C(n)=(Lmax(n)−Lmin(n))/(Lmax(n)+Lmin(n))

That is to say, the without-panel modulation contrast C(n) is a ratio of a difference of Lmax(n) and Lmin(n) to a sum of Lmax(n) and Lmin(n). For example, in the above formula, Lmax(n) is a maximum brightness value of the first region 1001 and the second region 1001 in the n^{th} pattern group 10 measured under a condition of without-panel detecting; Lmin(n) is a minimum brightness value of the first region 1001 and the second region 1002 in the n^{th} pattern group 10 measured under the condition of without-panel detecting.

In some examples, the with-panel modulation contrast is:

C′(n)=(L′max(n)−L′min(n))/(L′max(n)+L′min(n))

That is to say, the with-panel modulation contrast C′(n) is a ratio of a difference of L′max(n) and L′min(n) to a sum of L′max(n) and L′min(n). For example, in the above formula, L′max(n) is a maximum brightness value of the first region 1001 and the second region 1001 in the n^{th} pattern group 10 measured under a condition of with-panel detecting; L′min(n) is a minimum brightness value of the first region 1001 and the second region 1002 in the n^{th} pattern group 10 measured under the condition of with-panel detecting.

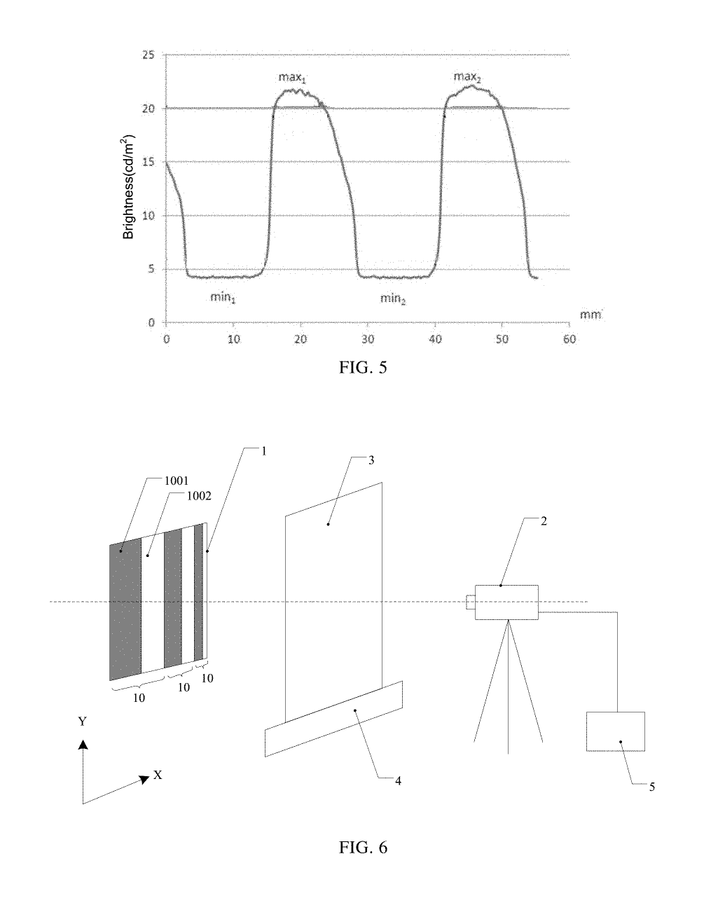

FIG. 5 illustrates a brightness curve of two pattern groups under a condition of with-panel detecting, for example, the two pattern groups are the first pattern group and the second pattern group respectively from left to right, and a with-panel modulation contrast of the first pattern group is:

C′(1)=(L′max 1−L′min1)/(L′max1+L′min1)

It can be seen from FIG. 5 that, L′max1=max1, L′min1=min1.

Similarly, a with-panel modulation contrast of the second pattern group is:

C′(2)=(L′max2−L′min2)/(L′max2+L′min2)

It can be seen from FIG. 5 that, L′max2=max2, L′min2=min2.

With-panel modulation contrasts of other pattern groups can refer to a calculation method of the with-panel modulation contrast of the above first pattern group and of the with-panel modulation contrast of the second pattern group. When the without-panel modulation contrast is calculated, the brightness curve acquired during without-panel detecting can be utilized. What needs to be noted is that, the without-panel modulation contrast and the with-panel modulation contrast are not limited to the above given method to calculate.

In some examples, upon without-panel detecting and with panel detecting are performed, distances between the measuring device 2 and the reference pattern sheet 1 are equal. The distances are set equal, and a reliable comparison result can be acquired. Distances among the measuring device, the transparent display panel and the reference pattern sheet can be adjusted as required. What needs to be noted is that, the without-panel detecting in the embodiment of the present disclosure refers to detecting performed in a case that the transparent display panel is not placed between the reference pattern sheet and the measuring device, and the with panel detecting refers to detecting performed in a case that the transparent display panel is placed between the reference pattern sheet and the measuring device.

In some examples, a gray scale of the first color is different from a gray scale of the second color. In one example, the first color is black, and the second color is white. If a range of a gray value is defined 0-255, and a gray value of the black is set 0, and a gray value of the white is set 255. The first color of the first region 1001 and the second color of the second region 1002 are not limited herein. For example, in some other examples, the first color can also be red, blue, or green or the like, and the second color can also be yellow, or pink or the like.

In some examples, a gray scale of the transparent display panel 3 is 0-255. In the detecting method of the embodiment of the present disclosure, the transparent display panel cannot display an image and can also display an image. Detecting of the clarity of the transparent display panel can be performed under a condition of a dark room, and can also be performed under ambient light irradiation, which is not limited herein, and conditions are same upon without-panel detecting and with-panel detecting are performed. When detecting is performed under the condition of the dark room, a light source can be provided and can also be not provided, which is not limited by the embodiment of the present disclosure. If the light source is provided, the light source can be provided on one side of the reference pattern sheet, and is separated from the reference pattern sheet by a fixed predetermined distance, and therefore uniform predetermined illuminance can be formed on the reference pattern sheet. In a case that the display panel displays an image, a color used at the time of detecting of the transparent display detecting is not limited, either, for instance, can be any of red (R), green (G), blue (B), cyan (C), magenta (M), and yellow (Y).

The modulation contrast in the embodiment of the present disclosure refers to a numerical value acquired after a numerical value of a contrast is processed, further, and for example refers to a numerical value acquired after a measurement value of the contrast is processed. Further, for example, it refers to a numerical value acquired when the measurement value of the contrast is calculated by means of a given method or a given formula. The given method or the given formula is not limited to a method or a formula described in the embodiment of the present disclosure.

An embodiment of the present disclosure further provides an apparatus for detecting the clarity of a transparent display panel, as illustrated in FIG. 6, including: a reference pattern sheet 1 and a measuring device 2.

The reference pattern sheet 1 includes a plurality of pattern groups 10 sequentially arranged (distributed) in a first direction, each of the plurality of pattern groups 10 includes a first region 1001 and a second region 1002, the first region 1001 has a first color, the second region 1002 has a second color different from the first color, and widths of the plurality of pattern groups 10 in the first direction are different.

The measuring device can be disposed to be separated from the reference pattern sheet 1 by a predetermined distance, and is configured to perform measurement in cases that the transparent display panel 3 is not placed between the measuring device 2 and the reference pattern sheet 1 and the transparent display panel is placed between the measuring device 2 and the reference pattern sheet 1 so as to acquire a without-panel measurement value and a with-panel measurement value of the reference pattern sheet 1. For example, the measuring device 2 can include a charge coupled device (CCD), a complementary metal oxide semiconductor (CMOS) device and other image acquisition devices; as required, the measuring device 2 can also include a storage device for storing acquired data and the like. For example, the measuring device 2 can be a brightness measuring device.

In the apparatus for detecting the clarity of the transparent display panel provided by the embodiment of the present disclosure, widths of the plurality of pattern groups 10 of the reference pattern sheet 1 are different, and the reference pattern sheet 1 is made to include two basic elements describing the clarity: acutance and resolution. Thus, measurement of the clarity can be more accurate. The clarity of the transparent display panel can be acquired in a calculation manner according to the without-panel measurement value and the with-panel measurement value measured by the apparatus for detecting the clarity of the transparent display panel provided by the embodiment of the present disclosure.

In some examples, in order to facilitate measurement, centers of the reference pattern sheet 1, the transparent display panel 3 and the measuring device 2 can be in one straight line.

In some examples, the apparatus for detecting the clarity of the transparent display panel can further include: a transparent display panel support device 4. The transparent display panel support device 4 is disposed between the measuring device 2 and the reference pattern sheet 1, and is configured to place the transparent display panel 3 between the measuring device 2 and the reference pattern sheet 1 or move out the transparent display panel 3 between the measuring device 2 and the reference pattern sheet 1.

The transparent display panel support device 4 is designed to place the transparent display panel 3 in an optical path between the measuring device 2 and the reference pattern sheet 1, or move out the transparent display panel 3 from the optical path between the measuring device 2 and the reference pattern sheet 1. For example, the transparent display panel 3 is disposed to be away from the reference pattern sheet 1 by 50 cm by using the transparent display panel support device 4. The transparent display panel support device 4 can be a support or a fixture or other support devices fixing the transparent display panel, and can move through a driver (not shown).

In some examples, the apparatus for detecting the clarity of the transparent display panel further includes: an evaluating device 5. The evaluating device 5 is configured to acquire a without-panel modulation contrast of each of the plurality of pattern groups 10 of the reference pattern sheet 1 according to the without-panel measurement value, a with-panel modulation contrast of each of the plurality of pattern groups 10 of the reference pattern sheet 1 according to the with-panel measurement value, and determine the clarity Cn of the transparent display panel 3 corresponding to an n^{th} pattern group 10 according to a ratio of the with-panel modulation contrast of the n^{th} pattern group 10 to the without-panel modulation contrast of the n^{th} pattern group 10. The clarity Cn is linearly proportional to the ratio:

Cn=k C′(n)/C(n)

where, C(n) is the without-panel modulation contrast of the n^{th} pattern group 10, C′(n) is the with-panel modulation contrast of the n^{th} pattern group 10, and n is an integer greater than 0, and k is a positive number.

In some examples, the evaluating device 5 is further configured to acquire a curve in which clarities of the transparent display panel 3 change along with a line pair frequency according to a line pair frequency of each of the plurality of pattern groups 10 and a clarity of each of the plurality of pattern groups 10, so as to acquire clarities of the transparent display panel 3 under different line pair frequencies, and a line pair frequency of the n^{th} pattern group 10 is a number of line pairs of the first region 1001 and the second region 1002 of the n^{th} pattern group in a unit length. The line pair frequency can be referred to related descriptions as described above.

For example, the evaluation device 5 can be connected with the measuring device, and records the without-panel measurement value and the with-panel measurement value acquired through the measuring device, and then further calculation is performed. The evaluation device 5 can be a computer or a computer module, for instance, CPU, DSP, PLC and the like, and for another example, the evaluation device can be achieved by means of hardware, software, firmware or a combination of the hardware, the software and the firmware, which is not limited herein. The evaluation device 5 can be used for substantially improving calculating efficiency.

In the apparatus for detecting the clarity of the transparent display panel provided by some examples, the widths of the plurality of pattern groups 10 gradually change in the first direction.

In the apparatus for detecting the clarity of the transparent display panel provided by some examples, the widths of the plurality of pattern groups 10 in the first direction gradually change in an arithmetic progression manner.

In the apparatus for detecting the clarity of the transparent display panel provided by some examples, the first region 1001 and the second region 1002 in each of the plurality of pattern groups 10 have a same width in the first direction.

In the apparatus for detecting the clarity of the transparent display panel provided by some examples, the first region 1001 and the second region 1002 in each of the plurality of pattern groups 10 have different widths in the first direction.

In the apparatus for detecting the clarity of the transparent display panel provided by some examples, a width changing tendency of a plurality of first regions 1001 in the first direction and a width changing tendency of a plurality of second regions 1002 in the first direction are the same.

In the apparatus for detecting the clarity of the transparent display panel provided by some examples, a gray scale of the first color is different from a gray scale of the second color.

In the apparatus for detecting the clarity of the transparent display panel provided by some examples, the first color is black, red, blue, or green, and the second color is white, yellow, or pink.

In the apparatus for detecting the clarity of the transparent display panel provided by some examples, a gray scale of the transparent display panel 3 is 0-255.

In the apparatus for detecting the clarity of the transparent display panel provided by some examples, the reference pattern sheet 1 has an annular target-shaped pattern with the first region 1001 and the second region 1002 nested, a strip-shaped pattern with the first region 1001 and the second region 1002 extending in a second direction, and a chessboard pattern or a grid pattern with first regions 1001 and second regions 1002 both alternately arranged in the first direction and the second direction, and the second direction is perpendicular to the first direction.

What needs to be noted is that, the reference pattern sheet, the transparent display panel, the first color and the second color can refer to related description in the method for detecting the clarity of the transparent display panel provided by the embodiment of the present disclosure, and are not repeated herein.

The method for detecting the clarity of the transparent display panel in the embodiments of the present disclosure can adopt the apparatus for detecting the clarity of the transparent display panel in the embodiment of the present disclosure to detect the clarity of the transparent display panel.

The transparent display panel in the embodiment of the present disclosure includes a liquid crystal transparent display panel, an organic light emitting diode (OLED) transparent display panel and the like.

The detecting method and the detecting apparatus for the clarity of the transparent display panel provided by the embodiments of the present disclosure, have at least one of following beneficial effects.

(1) The plurality of pattern groups 10 different in width are used as the reference pattern sheet 1, and two basic elements for describing the clarity are included: acutance and resolution. The acutance is, namely, a contrast, and the greater the contrast is, the clearer boundaries of the first region 1001 and the second region 1002 are; the resolution is, namely, a number of the pattern groups (for example, same pattern group) included in a unit length, and the greater the number is, the higher the resolution is. Thus, the reference pattern sheet 1 can make measurement of the clarity more accurate.

(2) By measuring the with-panel measurement value and the without-panel measurement value of the reference pattern sheet upon with-transparent display panel detecting and without-transparent display panel detecting, influences of a measuring device on a testing result are eliminated, and the clarity of the transparent display panel 3 and a degree of a transparent effect are directly reflected.

(3) The modulation contrast of each of the plurality of pattern groups, rather than a contrast of each of the plurality of pattern groups is used, and a degree of clarity of the reference pattern sheet is characterized more objectively and accurately.

The followings need to be noted.

(1) In the drawings of the embodiments of the present disclosure, only a structure related to the embodiments of the present disclosure is involved, and other structures can refer to general design.

(2) The features in different embodiments or different features in the same embodiments can be combined without conflict.

What have been described above are only specific implementations of the present disclosure, the protection scope of the present disclosure is not limited thereto. Any changes or substitutions easily occur to those skilled in the art within the technical scope of the present disclosure should be covered in the protection scope of the present disclosure. Therefore, the protection scope of the present disclosure should be based on the protection scope of the claims.

This application claims the benefit of priority from Chinese patent application No. 201610181493.2, filed on Mar. 28, 2016, the disclosure of which is incorporated herein in its entirety by reference as a part of the present application.

1. A method for detecting a clarity of a transparent display panel, comprising:
detecting directly a reference pattern sheet by a measuring device separated from the reference pattern sheet by a certain distance to obtain a without-panel measurement value of the reference pattern sheet;
placing the transparent display panel between the measuring device and the reference pattern sheet;
detecting the reference pattern sheet by the measuring device through the transparent display panel to obtain a with-panel measurement value of the reference pattern sheet;
acquiring clarity of the transparent display panel according to the without-panel measurement value and the with-panel measurement value;
wherein, the reference pattern sheet comprises a plurality of pattern groups sequentially arranged in a first direction, each of the plurality of pattern groups comprises a first region and a second region, the first region has a first color, the second region has a second color different from the first color, and widths of the plurality of pattern groups in the first direction are different.

2. The method for detecting the clarity of the transparent display panel according to claim 1, wherein,
a without-panel modulation contrast of each of the plurality of pattern groups is acquired according to the without-panel measurement value;
a with-panel modulation contrast of each of the plurality of pattern groups is acquired according to the with-panel measurement value;
a clarity Cn of the transparent display panel corresponding to an n^{th} pattern group is determined according to a ratio of the with-panel modulation contrast of the n^{th} pattern group to the without-panel modulation contrast of the n^{th} pattern group, and the clarity Cn is linearly proportional to the ratio:
Cn=k C′(n)/C(n)
where, C(n) is the without-panel modulation contrast of the n^{th} pattern group, C′(n) is the with-panel modulation contrast of the n^{th} pattern group, and n is an integer greater than 0, and k is a positive number.

3. The method for detecting the clarity of the transparent display panel according to claim 2, after acquiring the clarity Cn of the transparent display panel corresponding to the n^{th} pattern group , further comprising:
acquiring a curve in which clarities of the transparent display panel change along with a line pair frequency according to a line pair frequency of each of the plurality of pattern groups and clarity of each of the plurality of pattern groups, so as to acquire the clarities of the transparent display panel under different line pair frequencies, and the line pair frequency of the n^{th} pattern group is a number of line pairs of the first region and the second region of the n^{th} pattern group in a unit length.

4. The method for detecting the clarity of the transparent display panel according to claim 3, wherein, brightness values of the first region and the second region in each of the plurality of pattern groups are acquired by measuring a brightness curve of the reference pattern sheet.

5. The method for detecting the clarity of the transparent display panel according to claim 4, wherein,
the without-panel modulation contrast is:
C(n)=(Lmax(n)−Lmin(n))/(Lmax(n)+Lmin(n))
where, Lmax(n) is a maximum brightness value of the first region and the second region in the n^{th} pattern group measured under a condition of without-panel detecting; Lmin(n) is a minimum brightness value of the first region and the second region in the n^{th} pattern group measured under the condition of without-panel detecting.

6. The method for detecting the clarity of the transparent display panel according to claim 4, wherein,
the with-panel modulation contrast is:
C′(n)=(L′max(n)−L′min(n))/(L′max(n)+L′min(n))
where, L′max(n) is a maximum brightness value of the first region and the second region in the n^{th} pattern group measured under a condition of with-panel detecting; L′min(n) is a minimum brightness value of the first region and the second region in the n^{th} pattern group measured under the condition of with-panel detecting.

7. The method for detecting the clarity of the transparent display panel according to claim 1, wherein, the widths of the plurality of pattern groups gradually change in the first direction.

8. The method for detecting the clarity of the transparent display panel according to claim 7, wherein, the widths of the plurality of pattern groups in the first direction is gradually changed in an arithmetic progression manner.

9. The method for detecting the clarity of the transparent display panel according to claim 7, wherein, the first region and the second region in each of the plurality of pattern groups have a same width in the first direction.

10. The method for detecting the clarity of the transparent display panel according to claim 7, wherein, the first region and the second region in each of the plurality of pattern groups have different widths in the first direction.

11. The method for detecting the clarity of the transparent display panel according to claim 7, wherein, a width changing tendency of a plurality of first regions in the first direction and a width changing tendency of a plurality of second regions in the first direction are the same.

12-16 (canceled)

17. An apparatus for detecting a clarity of a transparent display panel, comprising:
a reference pattern sheet, wherein, the reference pattern sheet comprises a plurality of pattern groups sequentially arranged in a first direction, each of the plurality of pattern groups comprises a first region and a second region, the first region has a first color, the second region has a second color different from the first color, and widths of the plurality of pattern groups in the first direction are different;
a measuring device, wherein, the measuring device is arranged to be separated from the reference pattern sheet by a predetermined distance, and is configured to perform measurement in cases that the transparent display panel is not placed between the measuring device and the reference pattern sheet and the transparent display panel is placed between the measuring device and the reference pattern sheet so as to acquire a without-panel measurement value and a with-panel measurement value of the reference pattern sheet.

18. The apparatus for detecting the clarity of the transparent display panel according to claim 17, further comprising a support device for supporting the transparent display panel,
wherein, the support device is disposed between the measuring device and the reference pattern sheet, and is configured to place the transparent display panel between the measuring device and the reference pattern sheet or remove out the transparent display panel between the measuring device and the reference pattern sheet.

19. The apparatus for detecting the clarity of the transparent display panel according to claim 17, further comprising: an evaluating device,
wherein, the evaluating device is configured to acquire a without-panel modulation contrast of each of the plurality of pattern groups of the reference pattern sheet according to the without-panel measurement value, a with-panel modulation contrast of each of the plurality of pattern groups of the reference pattern sheet according to the with-panel measurement value, and determine a clarity Cn of the transparent display panel corresponding to an n^{th} pattern group according to a ratio of the with-panel modulation contrast of the n^{th} pattern group to the without-panel modulation contrast of the n^{th} pattern group, and the clarity Cn is linearly proportional to the ratio:
Cn=k C′(n)/C(n)
where, C(n) is the without-panel modulation contrast of the n^{th} pattern group, C′(n) is the with-panel modulation contrast of the n^{th} pattern group, and n is an integer greater than 0, and k is a positive number.

20. The apparatus for detecting the clarity of the transparent display panel according to claim 19, wherein, the evaluating device is further configured to acquire a curve in which clarities of the transparent display panel change along with a line pair frequency according to a line pair frequency of each of the plurality of pattern groups and clarity of each of the plurality of pattern groups, so as to acquire the clarities of the transparent display panel under different line pair frequencies, and a line pair frequency of the n^{th} pattern group is a number of line pairs of the first region and the second region of the n^{th} pattern group in a unit length.

21. The apparatus for detecting the clarity of the transparent display panel according to claim 17, wherein, the widths of the plurality of pattern groups gradually change in the first direction.

22. The apparatus for detecting the clarity of the transparent display panel according to claim 17, wherein, the widths of the plurality of pattern groups in the first direction gradually change in an arithmetic progression manner.

23. The apparatus for detecting the clarity of the transparent display panel according to claim 22, wherein, the first region and the second region in each of the plurality of pattern groups have a same width in the first direction.

24. The apparatus for detecting the clarity of the transparent display panel according to claim 22, wherein, the first region and the second region in each of the plurality of pattern groups have different widths in the first direction.

25. The apparatus for detecting the clarity of the transparent display panel according to claim 24, wherein, a width changing tendency of a plurality of first regions in the first direction and a width changing tendency of a plurality of second regions in the first direction are the same.

26-29 (canceled)
